(19) United States
(12) Patent Application Publication
(10) Pub. No.: US 2006/0036475 A1
(43) Pub. Date: Feb. 16, 2006

(54) Business activity debugger

(75) Inventors: Michael Gilfix, Austin, TX (US); David Perry Greene, Austin, TX (US); Vani Prasad, Austin, TX (US); Daniel R. Roth, Bothell, WA (US); William R. Salinas, Pittsburgh, PA (US); William Streit, Durham, NC (US); Scott Winters, Austin, TX (US)

Correspondence Address: IBM CORPORATION (CS);C/O CARR LLP, 670 FOUNDERS SQUARE, 900 JACKSON STREET, DALLAS, TX, 75202, US

(73) Assignee: International Business Machines Corporation, Armonk, NY (US)

(21) Appl. No.: 10/916,971

(22) Filed: Aug. 12, 2004

(51) Int. Cl. G06F 9/44

(52) U.S. Cl. 705/7

(57) ABSTRACT

A method, an apparatus, and a computer program are provided to better analyze business activities. Metrics are utilized to mine information gathered on a businesses operations. At times of user labeled events, snap shots of the state of the business can be taken. Statistical analyses are performed on the data corresponding to the state of the business to determine if correlations between user labeled events and business activities. Therefore, a business can become more competitive by determining the behaviors that both help and hurt business operations.

### FIELD OF THE INVENTION

The present invention relates generally to business dashboards and, more particularly, to the improve performance of a business dashboard.

### DESCRIPTION OF THE RELATED ART

Over recent years, business dashboards have become more commonplace. Business dashboards are essentially visual representations of business events. Through the use of middleware, such as computer networks, dashboards are able to collect and harvest data about a business. For example, tracking sales for a particular business sector, like energy, are commonly measured. The varying measurements are then refined using a variety of statistical analyses, like regression analysis.

The varying analyses, though, are of little use unless the information is provided to the correct persons. Hence, graphical and other user interfaces have been employed to provide information to employees. These employees, then, can use the information to make predictions and business judgments, which can lead to successes or failures, such as increase or decrease sales.

However, it is not entirely clear as to how successes or failures are predicted or what may cause the successes or failures. Currently, such measurements or correlation techniques to determine the characteristics of both predictions and successes do not exist.

Therefore, a need exists for a method and/or apparatus for determining the characteristics of predictions in a business dashboard environment that addresses at least some of the problems associated with conventional business dashboards.

### SUMMARY OF THE INVENTION

The present invention provides an apparatus, method, and computer program for debugging business activities. A plurality of metrics and a plurality of source databases are provided. Each metric is configured to choose and process data from the source databases according to predefined criteria to produce refined data. Also, the metrics are coupled to a user interface. Included in the middleware is a processor, wherein the processor utilizes statistically analysis with the refined data at or after a user labeled event. The statistical analysis determines if there is an association between the user defined event and the refined data.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 is a block diagram depicting a business dashboard system; and

FIG. 2 is a flow chart depicting the operation of a business dashboard that measures states of companies.

### DETAILED DESCRIPTION

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, details concerning network communications, electro-magnetic signaling techniques, and the like, have been omitted inasmuch as such details are not considered necessary to obtain a complete understanding of the present invention, and are considered to be within the understanding of persons of ordinary skill in the relevant art.

It is further noted that, unless indicated otherwise, all functions described herein may be performed in either hardware or software, or some combination thereof. In a preferred embodiment, however, the functions are performed by a processor such as a computer or an electronic data processor in accordance with code such as computer program code, software, and/or integrated circuits that are coded to perform such functions, unless indicated otherwise.

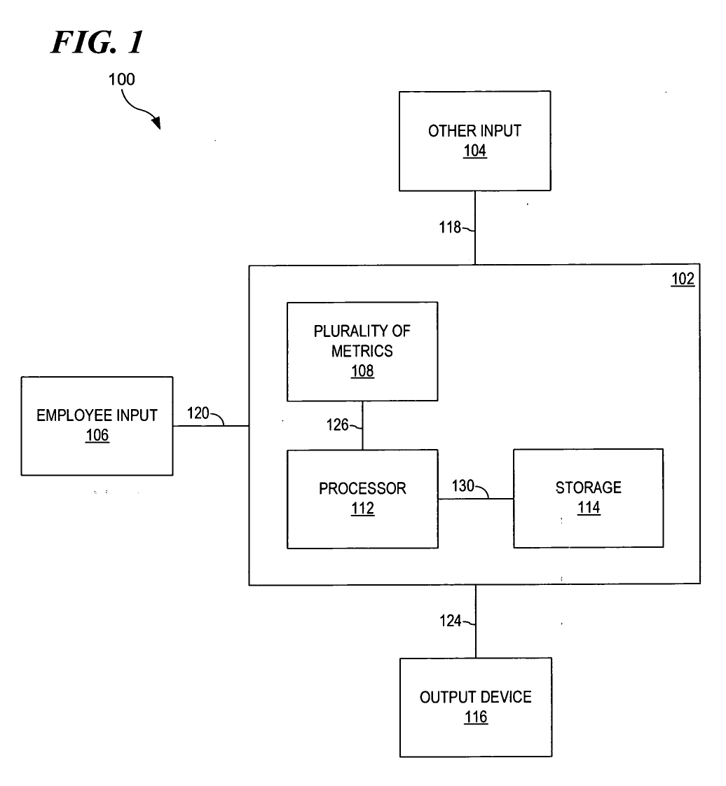

Referring to FIG. 1 of the drawings, the reference numeral 100 generally designates a business dashboard system. The business dashboard 100 comprises middleware 102, employee input 106, other input 104, and output 118.

In order for the business dashboard to operate and effectively measure the performance of a company, middleware 102 is utilized. The middleware 102 comprises a processor with an incorporated predictive algorithm 112, a plurality of metrics 108, and storage 114. The plurality of metrics 108 is essentially the receiver portion of the middleware 102. Each of the plurality of metrics 108 defines a manner in which a measurement can be taken. Typically, metrics 108 are subroutines that collect and mine data, wherein the data is derived from a specific source or type of source, such as financial databases. Metrics, too, can be tired to a user interface. By coupling a metric to a user interface, a user can easily manipulate the measurements for the middleware 102 and user labeled events. For example, if a metric is utilized to determine the state of a business that operates in multiple sectors, such as the energy industry, a metric can collect financial data, sales data, and so forth of a company concerning the energy industry. The metrics can collect data from employee input 106, such as hourly time invested by an employee or employees, and can collect from other input 104, such as from financial databases. Each of the employee inputs 106 and the other inputs 104 are coupled to the middleware 102 through a first communication channel 120 and a second communication channel 118 to provide the means of communication between the middleware 102 and the inputs 104 and 106.

Once the data has been collected, the data is then processed. A processor 112 is utilized to process the input data from the employee inputs 106 and the other inputs 104 that has been refined by the metrics 108. Typically, the processor 112 employs a predictive or pattern recognition algorithm to determine possible patterns of behaviors that may have caused a particular event, be it a relatively good or bad event. The data from the plurality of metrics 108 is provided to the processor 112 through a third communication channel 126. Once the predictive algorithm utilized by the processor 112 has processed the data refined by a metric 108, a resultant, recognized pattern, if any, is communicated. The processor 112 can then store the resultant, recognized pattern, or lack thereof, in storage 114. The processor 112 communicates the resultant, recognized pattern, or lack thereof, to storage through a fourth communication channel 130.

Once the data has been processed and stored, the recognized pattern can be displayed to a user. The recognized pattern is output from the middleware 102 to an output device 116 through a fifth communication channel 124. The business dashboard 100, though, does not appear to be different from conventional dashboards, except that the pattern recognition used by the processor 112 is substantially different.

The predictive algorithm used by the processor 112 operates by effectively taking snap shot of the state of a company or division of a company. The processor 112 determines when a user labeled event, such as a good event or a bad event, has occurred. The good or bad event can be the improved sales or some recognized trend. For example, a recognized trend could be specific growth of a portion of an industrial sector. The processor 112 could be then prompted to take such a snap shot of the state of a company or division of a company. Once the snap shot of the state of the company or division of a company has been taken, then the predictive algorithm used by the processor 112 employs statistical analysis, such as regression analysis, to determine why the a user labeled event, such as a good event or a bad event, occurred. The event or prediction could be as a result of the type of information gathered by a specific employee, or the event could be as a result of chance when there appears to be no statistical significance.

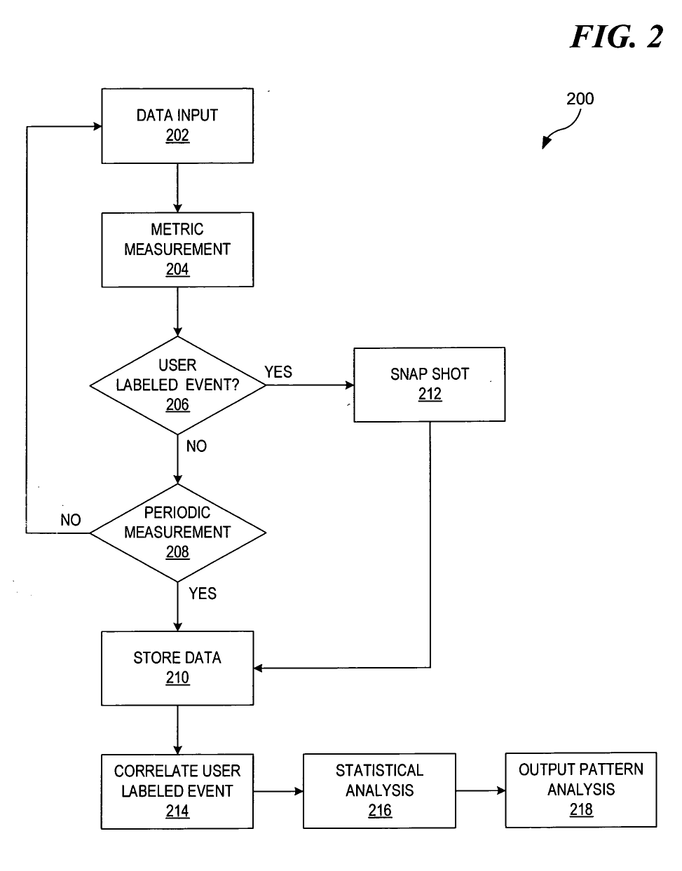

Referring to FIG. 2 of the drawings, the reference numeral 200 generally designates a flow chart depicting the operation of a business dashboard that measures states of companies.

The entire process of measuring the state of a company begins with data entry. In step 202, data is entered into the business dashboard of FIG. 1. The data can be from multiple types of sources, such as employees or financial databases.

The data that is entered, though, is meaningless unless the data is organized. Organization of data is accomplished through data mining. Data mining is the sorting and the selecting of data based on specified criteria, which is accomplished through the use of metrics. In step 204, metric measurements are taken. Metrics are the specific manner in which data is measured. For example, return on investments, churn rates, revenues, and so forth are all metrics. The metrics are usually deployed in algorithms that mine the input data.

Once the data has been mined, a determination of whether a user labeled event, such as a good or bad event, has occurred in step 206. The user labeled event, such as good or bad events, can be characterized in many ways. For example, exceeding expected earnings for a particular sector and an employee prediction of a small market depression could be characterized as a good and bad event respectively. The characterization of user labeled events can be preprogrammed into the business dashboard 100 of FIG. 1, manually requested, or both. Additionally, the good or bad event can be selecting arbitrarily with no predefined criteria. In any event, if there has not been a good or bad event, then there is a determination of whether a periodic measurement of the state of the system should be taken in step 208. If not, then the business dashboard 100 of FIG. 1 simply continues to receive input in step 202.

However, if a user labeled event, such as a good event or a bad event, occurs or a request for a periodic measurement occurs, then the data is properly processed. For a user labeled event, such as a good event or a bad event, a snap shot of all of the input data is taken. Effectively, the state of the company or division of the company is captured. The data gathered by the specific metric is stored in step 210. Then, an algorithm begins to analyze the data gathered by the metric in step 214. Many types of statistical analyses, such as linear regression analysis, multiple regression analysis, nonlinear least square fitting, and so forth, can be employed to determine trends in step 216. Once the business dashboard 100 of FIG. 1 has completed the statistical analysis, an output pattern can be yielded in step 218. The patterns can be as a result of the receipt of information to the correct employees or some other statistically significant phenomenon, or there may be no pattern at all.

The benefit of utilizing such a dashboard system, such as the business dashboard 100 of FIG. 1, is to improve performance. By allowing a business to effectively take a snap shot of the company or division of the company at a user labeled events, such as good events or bad events, a company can determine what has been done correctly and incorrectly. Utilization of varying metrics in combination with the snap shots allows for a nearly infinite number of analyses that can be performed to determine the behavior or behaviors that caused an event. Therefore, a clear advantage of the business dashboard 100 of FIG. 1 is the ability to determine correct and incorrect behavioral patterns by employees, markets, and others to better tailor business models and business behaviors to improve overall performance.

It is understood that the present invention can take many forms and embodiments. Accordingly, several variations may be made in the foregoing without departing from the spirit or the scope of the invention. The capabilities outlined herein allow for the possibility of a variety of programming models. This disclosure should not be read as preferring any particular programming model, but is instead directed to the underlying mechanisms on which these programming models can be built.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by those skilled in the art based upon a review of the foregoing description of preferred embodiments. Accordingly, it is appropriate that the appended claims be construed broadly and in a manner consistent with the scope of the invention.

1. A method for debugging business activities, comprising:
collecting business activity data from a plurality of sources;
refining the business activity data with a metric to produce refined data, wherein the metric is at least configured to utilize predefined criteria to at least choose and process data elements of the business activity data to produce the refined data, and wherein the metric is at least coupled to a user interface;
capturing the refined data when an user defined event occurs to produce stored data, wherein the capturing is at least configured to be user driven; and
statistically analyzing the stored data to determine patterns associated with the event.

2. The method of claim 1, wherein the step of capturing the refined data when an event occurs further comprises at least utilizing a predefined, user labeled good or bad event.

3. The method of claim 1, wherein the step of capturing the refined data when an event occurs further comprises arbitrarily selecting an event.

4. The method of claim 1, wherein the step of statistically analyzing the stored data to determine patterns associated with the event further comprises at least utilizing a statistical analysis selected from the group consisting of linear regression analysis, multiple regression analysis, and nonlinear least square fitting.

5. The method of claim 1, wherein the step of collecting business activity data from a plurality of sources, further comprises collecting data at least from financial databases.

6. A computer program product for debugging business activities in a computer system, the computer program product having a medium with a computer program product embodied thereon, the computer program comprising:
computer code for collecting business activity data from a plurality of sources;
computer code for refining the business activity data with a metric to produce refined data, wherein the metric is at least configured to utilize predefined criteria to at least choose and process data elements of the business activity data to produce the refined data, and wherein the metric is at least coupled to a user interface;
computer code for capturing the refined data when an user defined event occurs to produce stored data, wherein the capturing is at least configured to be user driven; and
computer code for statistically analyzing the stored data to determine patterns associated with the event.

7. The computer program product of claim 6, wherein the computer code for capturing the refined data when an event occurs further comprises at least utilizing a predefined, user labeled good or bad event.

8. The computer program product of claim 6, wherein the computer code for capturing the refined data when an event occurs further comprises arbitrarily selecting an event.

9. The computer program product of claim 6, wherein the computer code for statistically analyzing the stored data to determine patterns associated with the event further comprises at least utilizing a statistical analysis selected from the group consisting of linear regression analysis, multiple regression analysis, and nonlinear least square fitting.

10. The computer program product of claim 6, wherein the computer code for collecting business activity data from a plurality of sources, further comprises computer code for collecting data at least from financial databases.

11. A processor for debugging business activities in a computer system, the processor including a computer program comprising:
computer code for collecting business activity data from a plurality of sources;
computer code for refining the business activity data with a metric to produce refined data, wherein the metric is at least configured to utilize predefined criteria to at least choose and process data elements of the business activity data to produce the refined data, and wherein the metric is at least coupled to a user interface;
computer code for capturing the refined data when an user defined event occurs to produce stored data, wherein the capturing is at least configured to be user driven; and
computer code for statistically analyzing the stored data to determine patterns associated with the event.

12. The computer code of claim 11, wherein the computer code for capturing the refined data when an event occurs further comprises at least utilizing a predefined, user labeled good or bad event.

13. The computer code of claim 11, wherein the computer code for capturing the refined data when an event occurs further comprises arbitrarily selecting an event.

14. The computer code of claim 11, wherein the computer code for statistically analyzing the stored data to determine patterns associated with the event further comprises at least utilizing a statistical analysis selected from the group consisting of linear regression analysis, multiple regression analysis, and nonlinear least square fitting.

15. The computer code of claim 11, wherein the computer code for collecting business activity data from a plurality of sources, further comprises computer code for collecting data at least from financial databases.

16. An apparatus for debugging business activities, comprising:
a plurality of source databases;
a plurality of metrics, wherein each metric of the plurality metrics is at least configured choose and process data from the plurality of source databases according to predefined criteria to produce refined data, and wherein the metric is at least coupled to a user interface; and
a processor, wherein the processor is at least configured to utilize statistical analyses with the refined data at or after a user labeled event to produce a statistical analysis, and wherein the statistical analysis is at least configured to determine an association between the user defined event and the refined data.

17. The apparatus of claim 16, wherein the user labeled event further comprises a predefined good or bad event.

18. The apparatus of claim 16, wherein the user defined event further comprises an arbitrarily selected event.

19. The apparatus of claim 16, wherein the statistical analysis further comprises being selected from the group consisting of linear regression analysis, multiple regression analysis, and nonlinear least square fitting.

20. The apparatus of claim 16, wherein the plurality of source databases further comprises a plurality of financial databases.
